(19) United States
(12) Patent Application Publication
(10) Pub. No.: US 2013/0002530 A1
(43) Pub. Date: Jan. 3, 2013

(54) SEGMENT DISPLAY DEVICE

(75) Inventors: Ming-Chuan Hung, Hsinchu City (TW); Sung-Hui Huang, Hsinchu City (TW); Po-Wen Hsiao, Hsinchu City (TW); Huai-Tse Yang, Hsinchu City (TW); Chien-Feng Hsu, Hsinchu City (TW)

(73) Assignee: E Ink Holdings Inc., Hsinchu City (TW)

(21) Appl. No.: 13/491,832

(22) Filed: Jun. 8, 2012

(30) Foreign Application Priority Data
Jul. 1, 2011 (TW) 100123365

(51) Int. Cl. G09G 3/34

(52) U.S. Cl. 345/107

(57) ABSTRACT

A segment display device includes an e-paper segmented display module, a first circuit module and a second circuit module. The e-paper segmented display module includes a group of first contacts. The first circuit module includes a first substrate, a first control unit, a group of second contacts and a group of third contacts. The first control unit, the second contacts and the third contacts are disposed on the first substrate. The first control unit is electrically connected with the second contacts and the third contacts. The second contacts are electrically connected to the first contacts. The second circuit module includes a second substrate, a second control unit and a group of fourth contacts. The second control unit and the fourth contact group are electrically connected with each other and both are disposed on the second substrate. The fourth contacts are electrically connected to the third contacts.

### TECHNICAL FIELD

The present invention relates to display devices, and more particularly to a segment display device.

### BACKGROUND

With rapid development of technology, segment display devices have become widely used in various electronic devices, such as digital clocks, signages and price tags. Furthermore, e-paper displays, such as electrophoretic displays, quick response-liquid powder displays (QR-LPD) and electro-wetting displays (EWD), have the advantages of small thickness and low power consumption, and are thereby widely used in electronic devices with compact design.

Taking an electrophoretic display as an example, the electrophoretic display employs an applied electric field to control the rearrangement of charged pigment particles and accordingly change the reflectivity of a display area relative to the ambient light. Thus, a visible image is obtained on the display area. The electrophoretic display has the advantages of reduced thickness and low power consumption because the electrophoretic display has the characteristic of bistability and no extra light source is needed.

However, in a typical conventional segment display device, a liquid crystal display (LCD) is generally employed as the display unit, which will cause a waste of electricity and an inconvenient use of the segment display device.

Therefore, it is desirable to provide a segment display device, which can overcome or at least alleviate the limitations described above.

### SUMMARY

The present invention provides a segment display device including an e-paper segmented display module, a first circuit module and a second circuit module. The e-paper segmented display module includes a group of first contacts. The first circuit module includes a first substrate, a first control unit, a group of second contacts and a group of third contacts. The first control unit, the second contacts and the third contacts are disposed on the first substrate. The first control unit is electrically connected with the second contacts and the third contacts. The second contacts are electrically connected to the first contacts. The second circuit module includes a second substrate, a second control unit and a group of fourth contacts. The second control unit and the fourth contacts are disposed on the second substrate. The second control unit is electrically connected with the fourth contacts. The fourth contacts are electrically connected to the third contacts.

The present invention further provides a segment display device including an e-paper segmented display module and a circuit module. The e-paper segmented display module includes a first control unit and a group of first contacts electrically connected with the first control unit. The circuit module includes a substrate, a second control unit, and a group of second contacts. The second control unit is electrically connected with the second contacts. The second control unit and the second contacts are disposed on the substrate. The first contacts are electrically connected to the second contacts.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, exploded view of a segment display device according to a first exemplary embodiment.

FIG. 2 is a schematic, exploded view of a segment display device according to a second exemplary embodiment.

FIG. 3 is a schematic, exploded view of a segment display device according to a third exemplary embodiment.

FIG. 4 is a schematic, exploded view of a segment display device according to a fourth exemplary embodiment.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

Referring to FIG. 1, a schematic, exploded view of a segment display device 10, according to a first exemplary embodiment, is shown. The segment display device 10 includes an e-paper segmented display module 12, a first circuit module 14 and a second circuit module 16. The e-paper segmented display module 12 includes a group of first contacts 122. The first circuit module 14 includes a first substrate 142, a first control unit 144, a group of second contacts 146 and a group of third contacts 148. The first control unit 144, the second contacts 146 and the third contacts 148 are disposed on the first substrate 142. The first control unit 144 is electrically connected with the second contacts 146 and the third contacts 148. The second contacts 146 are electrically connected to the first contacts 122. The second circuit module 16 includes a second substrate 162, a second control unit 164 and a group of fourth contacts 166. The second control unit 164 is electrically connected with the fourth contacts 166. The second control unit 164 and the fourth contacts 166 are disposed on the second substrate 162. The fourth contacts 166 are electrically coupled to the third contacts 148.

In the present embodiment, the e-paper segmented display module 12 is, for example, an electrophoretic-type e-paper segmented display module.

The first circuit module 14 is electrically connected between the e-paper segmented display module 12 and the second circuit module 16. In detail, the first control unit 144 can include a micro control unit (MCU) or a driver IC, which can support a variety of signal transmission interface protocols, such as serial peripheral interface (SPI), inter-integrated circuit (I²C). The second contacts 146 are electrically connected to the first contacts 122 so that signals can be transmitted between the e-paper segmented display module 12 and the first circuit module 14. The first contacts 122 can be electrically connected to the second contacts 146 by an anisotropic conductive film (ACF), an anisotropic conductive paste (ACP) or a connector. Further, in the present embodiment, the first circuit module 14 can also include a group of first passive electronic components 149 disposed on the first substrate 142. The first passive electronic components 149 can be resistors, capacitors, crystal oscillators or switches.

The second circuit module 16 can be an input device such as a keyboard. The second control unit 164 is similar to the first control unit 144 and can also include a micro control unit (MCU) or a driver IC, which can support a variety of signal transmission interface protocols, such as serial peripheral interface (SPI), inter-integrated circuit (I²C). The fourth contacts 166 are electrically connected to the third contacts 148 so that signals can be transmitted between the second circuit module 16 and the first circuit module 14. Similar to the interconnection between the second contacts 146 and the first contacts 122, the fourth contacts 166 can be electrically connected to the third contacts 148 via an anisotropic conductive film (ACF), an anisotropic conductive paste (ACP) or a connector. Further, in the present embodiment, the second circuit module 16 can also include a group of second passive electronic components 168 and a power supply device 169. Both the second passive electronic components 168 and the power supply device 169 are disposed on the second substrate 162. The second passive electronic components 168 can be resistors, capacitors, crystal oscillators or switches. The power supply device 169 is configured for supplying power to the e-paper segmented display module 12, the first circuit module 14 and the second circuit module 16. The power supply device 169 can be, without limitation, disposable batteries or rechargeable batteries. In other embodiments, the segment display device 10 can be provided with a plug for connecting to an external power supply to get power without using the power supply device 169.

The segment display device 10 employs the e-paper segmented display module 12 as a display unit. Since the e-paper segmented display module 12 has an advantage of small thickness and low power consumption, the segment display device 10 is therefore beneficial to decrease the overall power consumption and improve the reliability during operation. Furthermore, the e-paper segmented display module 12, the first circuit module 14 and the second circuit module 16 are connected to each other in a cooperative manner to thereby improve the convenience of use and the performance of the segment display device 10.

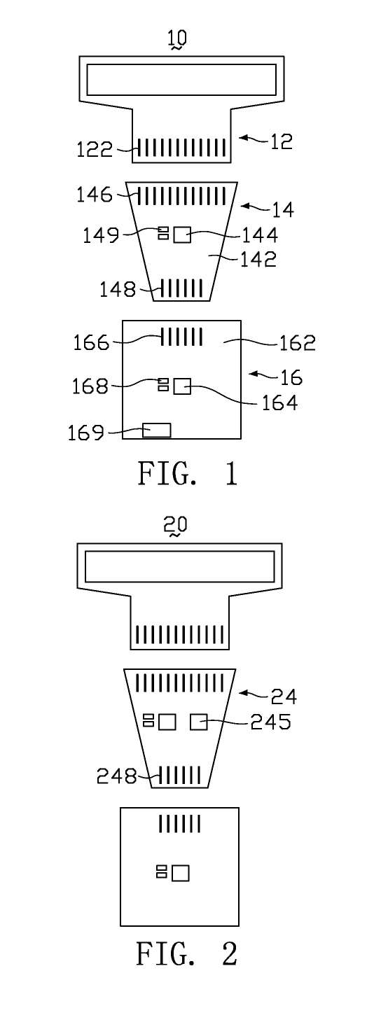

Referring to FIG. 2, a schematic, exploded view of a segment display device 20, according to a second exemplary embodiment, is shown. The segment display device 20 of this embodiment is similar to the segment display device 10 of the first embodiment. The difference lies in that the first circuit module 24 of the present embodiment further includes a chip 245. The chip 245 can be electrically connected to the third contacts 248 or other additionally provided contacts to increase the number of input/output interfaces for the first circuit module 24, to thereby further expand the using scope of the segment display device 20.

Referring to FIG. 3, a schematic, exploded view of a segment display device 30, according to a third exemplary embodiment, is shown. The segment display device 30 of this embodiment is similar to the segment display device 10 of the first embodiment. In the present embodiment, the segment display device 30 includes an e-paper segmented display module 32 and a first circuit module 34. The e-paper segmented display module 32 includes a group of first contacts 322 and a first control unit 324 electrically connected to the first contacts 322. The first circuit module 34 includes a first substrate 342, a second control unit 344 and a group of second contacts 346. The second control unit 344 and the second contacts 346 are electrically connected to each other and both are disposed on the first substrate 342. The first contacts 322 are electrically connected to the second contacts 346. In addition, the e-paper segmented display module 32 can further include a group of passive electronic components 326, and the first circuit module 34 can also include a group of passive electronic components 348. In the present embodiment, the first control unit 324 and the passive electronic components 326 are directly formed on the e-paper segmented display module 32, whereby a substrate can be omitted so as to reduce the cost of the segment display device 30.

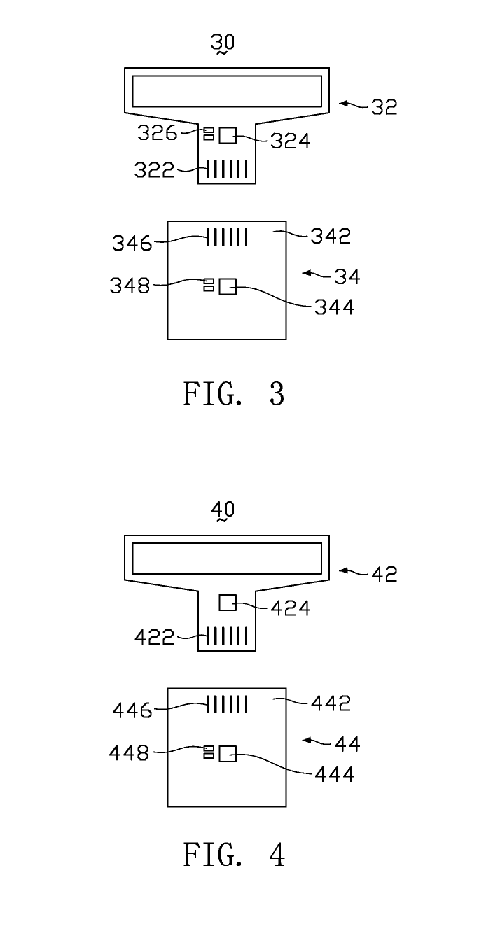

Referring to FIG. 4, a schematic, exploded view of a segment display device 40, according to a fourth exemplary embodiment, is shown. The segment display device 40 of this embodiment is similar to the segment display device 30 of the third embodiment. In the present embodiment, the segment display device 40 includes an e-paper segmented display module 42 and a first circuit module 44. The e-paper segmented display module 42 includes a group of first contacts 422 and a first control unit 424 electrically connected to the first contacts 422. The first circuit module 44 includes a first substrate 442, a second control unit 444 and a group of second contacts 446. The second control unit 444 and the second contacts 446 are electrically connected to each other and both are disposed on the first substrate 442. The first contacts 422 are electrically connected to the second contacts 446. In particular, the first circuit module 44 can further include a group of passive electronic components 448, while no passive electronic components are formed on the e-paper segmented display module 42. In the present embodiment, the e-paper segmented display module 42 has no passive electronic components formed thereon, whereby the volume and the manufacturing difficulty of the segment display device 40 are reduced and the reliability thereof is improved.

The segment display devices illustrated above provide the e-paper segmented display module as the display unit. Since the e-paper segmented display module has an advantage of small thickness and low power consumption, the segment display devices are beneficial to decrease the overall power consumption and improve the reliability during operation. Furthermore, the e-paper segmented display module, the first circuit module and the second circuit module are electrically connected to each other in a cooperative manner, to thereby improve the convenience of use and the performance of the segment display devices.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A segment display device comprising:
an e-paper segmented display module comprising a group of first contacts;
a first circuit module comprising a first substrate, a first control unit, a group of second contacts and a group of third contacts, wherein the first control unit, the second contacts and the third contacts are disposed on the first substrate, the first control unit is electrically connected with the second contacts and the third contacts, and the second contacts are electrically connected to the first contacts; and
a second circuit module comprising a second substrate, a second control unit and a group of fourth contacts, wherein the second control unit and the fourth contacts are disposed on the second substrate, the second control unit is electrically connected with the fourth contacts, and the fourth contacts are electrically connected to the third contacts.

2. The segment display device according to claim 1, wherein the first control unit is selected from one of a micro control unit (MCU) and a driver IC.

3. The segment display device according to claim 1, wherein the second control unit is selected from one of a micro control unit (MCU) and a driver IC.

4. The segment display device according to claim 1, wherein the first contacts are electrically connected to the second contacts by one of an anisotropic conductive film (ACF), an anisotropic conductive paste (ACP) and a connector.

5. The segment display device according to claim 1, wherein the third contacts are electrically connected to the fourth contacts by one of an anisotropic conductive film (ACF), an anisotropic conductive paste (ACP) and a connector.

6. The segment display device according to claim 1, wherein the e-paper segmented display module is an electrophoretic-type e-paper segmented display module.

7. The segment display device according to claim 1, wherein the first circuit module further includes a group of first passive electronic components disposed on the first substrate, and the second circuit module further includes a group of second passive electronic components disposed on the second substrate.

8. The segment display device according to claim 1, wherein the first circuit module further includes a chip disposed on the first substrate to form an input/output interface for the first circuit module.

9. The segment display device according to claim 1, wherein the second circuit module further includes a power supply device connected to the second control unit and the fourth contacts.

10. A segment display device comprising:
an e-paper segmented display module comprising a first control unit and a group of first contacts electrically connected to the first control unit; and
a circuit module comprising a substrate, a second control unit and a group of second contacts electrically connected to the second control unit, wherein the second control unit and the second contacts are disposed on the substrate, and the first contacts are electrically connected to the second contacts.

11. The segment display device according to claim 10, wherein the e-paper segmented display module further includes a group of first passive electronic components formed thereon, and the circuit module further includes a group of second passive electronic components disposed on the substrate.

12. The segment display device according to claim 10, wherein the circuit module further includes a group of passive electronic components disposed on the substrate.

13. The segment display device according to claim 10, wherein the first control unit is selected from one of a micro control unit (MCU) and a driver IC.

14. The segment display device according to claim 10, wherein the second control unit is selected from one of a micro control unit (MCU) and a driver IC.

15. The segment display device according to claim 10, wherein the first contacts are electrically connected to the second contacts by one of an anisotropic conductive film (ACF), an anisotropic conductive paste (ACP) and a connector.

16. The segment display device according to claim 10, wherein the e-paper segmented display module is an electrophoretic-type e-paper segmented display module.
